(19) United States
(12) Patent Application Publication
(10) Pub. No.: US 2022/0256828 A1
(43) Pub. Date: Aug. 18, 2022

(54) Fishing Knot Protector

(71) Applicant: Current, LLC, Eagle, ID (US)

(72) Inventors: Ryan Kuhns, Eagle, ID (US); Randy McAbee, Bakersfield, CA (US)

(21) Appl. No.: 17/651,448

(22) Filed: Feb. 17, 2022

Related U.S. Application Data
(60) Provisional application No. 63/150,331, filed on Feb. 17, 2021.

(51) Int. Cl. A01K 91/08

(52) U.S. Cl. CPC A01K 91/08

(57) ABSTRACT

A fishing knot protector is provided to protect the knot between a fishing line and lure or other fishing accessory. The fishing knot protector is preferably formed in a conical shape with an interior passageway or void configured for housing the knot to be protected. Preferably the interior passageway includes two cavities with one formed to protect the knot in the fishing line and the second to house the eye of the device to which the line is attached. The two cavities are aligned between the tip and the base of the knot protector. The cavity nearest the base preferably has a flange that serves as the base and has an opening for insertion of the eye of the hook through the opening. Preferably the flange is configured with a material and size that secures the eye of the hook in the cavity proximate the base. A guide line or wire can be provided to assist in directing the fishing line through the knot protector to be secured to the eye of the hook or other accessory device, such as a swivel.

### PRIORITY/REFERENCE TO RELATED APPLICATIONS

This application claims the benefit of U.S. Provisional Application No. 63/150,331, filed Feb. 17, 2021 the disclosure of which is incorporated by reference.

### TECHNICAL FIELD

The disclosure generally relates to the field of fishing. Particularly, the disclosed embodiments relate to a novel fishing knot protector.

### BACKGROUND

Fishing has been a common method of obtaining a sustainable food source for thousands of years. Fishing is also a common recreation, enjoyed by many individuals. Whether fishing for food or recreation or both, there is a common requirement of a line and a hook. In the most basic sense, the hook allows the individual to catch the fish whereas the line allows the individual to pull the fish toward the fisherman and subsequently out of the water.

Hooks and lines of various kinds have been used in fishing when mankind first began to fish for food. These items have continued to be a principal part of fishing since then all the way up until now. A common type of fishing line that is currently in use is a monofilament line. Monofilament lines are generally made from a mixture of polymers that are heated until liquefied. Once liquid, the mixture is fed through a tiny hole to extrude a strand of line and then quickly cooled to be solidified. The strands are then wound onto spools to be sold.

Over the years, hooks have evolved to include various improvements. Things such single or multiple barbed hooks are now common. Additionally, hooks can be found in a variety of sizes, all of which may correspond to the specific fish the individual is attempting to catch. Modern hooks and other fishing devices, such as swivels, lures, and other fishing devices, typically utilize a formed eye through which the fishing line is attached to the hook. As used herein a hook, swivel, lure, or other fishing product that is attached to the fishing line by a knot and through a loop or eye on the fishing product is hereinafter referred to as a “fishing device”.

However, even with the improvements to the hooks and the use of modern monofilament fishing line, an individual is not guaranteed to catch a fish while out fishing. Instead, an individual can spend hours out by the water waiting for a fish to take hold of their hook. A common fishing practice is the cast and retrieve method. What is meant by that is an individual will cast their hook and line out into the water and then slowly (or quickly) reel it back in. The process may be repeated over and over until the individual finally gets a bite.

A popular fishing recreation that employs this technique is fishing for bass, a type of fish. Bass fishing is a favorite among both avid recreational fishermen and the more common fisherman. A successful bass fisherman will employ many different tactics throughout their endeavor in an effort to find the tactic that works the best on that particular day on the water. The tactics employed and the tactics that will ultimately be successful on any given day depend on a variety of factors. Some of these factors include the time of day, the temperature outside, the temperature of the water, the depth of water you are fishing at, the time of year, and even whether you are fishing in direct sunlight or on a shaded part of the water.

Bass are predators in their natural habitats. The bass will hide and then strike at smaller prey. This results in bass commonly being found hiding among sunken rocks or water vegetation. Bass are also commonly found under roots or limbs of sunken trees. This positioning allows them to strike at unsuspecting prey. However, this positioning can also result in several problems and/or annoyances for the fisherman targeting the bass.

Because of the likely location of the bass in the water, a problem that a fisherman is likely to incur when casting and reeling the hook and line back in is that it can cross weeds or moss in the body of water being fished. When this happens, the weeds or moss may become entangled on the individual's line and/or get caught down around the hook. The weeds or moss also commonly get hung up on the knot that holds the hook to the line. At this point, because of the ridged edges of the knot, the weed or moss are more likely to get caught than along other places of the fishing line and can even damage or break the line.

This requires the fisherman to remove the hook and line from the water and manually detangle the weeds or moss from the line, and typically recheck the knot, before recasting back out into the water. Depending on the significance of entanglement, the fisherman may be required to cut the line and remove the hook/lure from the weeds or moss and then re-knot it to the line. This problem can occur over and over to a fisherman while out fishing and result in a significant annoyance and even a waste of fishing line.

It is also common when fishing for bass to cast among the sunken rocks or trees or roots. When doing so, the hook and line is likely to rub against these sunken objects. This rubbing can cause abrasions on the monofilament line, weakening the line integrity. This can eventually lead to the line breaking. If the line were to break, the hook and/or lure on the line would be lost to the water. Because the knot connecting the hook/lure to the line represents a raised area when compared to the rest of the line, this specific area can be more susceptible to abrasion resulting in a weaker knot.

Abrasions to the line and knotted portion may also be caused by the fish themselves. Depending on the fish species the fisherman is attempting to catch, the fish biting on the hook/lure may cause abrasions to the line based on the anatomy of their mouths and teeth. This biting, resulting in abrasions to the line/knot, can lead to a weakened line making it more likely to break.

To combat this problem, a fisherman will have to routinely check his line for abrasions and ensure the integrity of the line and knot connecting the hook/lure thereto. This process can result in the fisherman having to cut away a part of the line above the abrasions to ensure the line maintains its integrity. Depending on the location of the abrasion on the line, it can be as simple as cutting several inches above the hook and re-knotting it or having to cut several feet of line off. This can not only result in annoyance to the fisherman but also result in a waste of significant portion of fishing line.

### SUMMARY OF THE INVENTION

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

To address the above described problems, the knot that holds the hook and line together will be protected in sock-like device. The sock-like device will provide a smooth surface covering over the knot and head of a hook/lure and protect the integrity of the knot from abrasions.

The claimed invention relates to fishing and fishing accessories. Specifically, the invention relates to a novel fishing knot protector that may be readily adopted for use with any fishing hook, lure, swivels, or any other fishing device where a knot is used.

While certain exemplary embodiments are shown in the Figures and described in this disclosure, it is to be distinctly understood that the presently disclosed inventive concept(s) is not limited thereto but may be variously embodied to practice within the scope of this disclosure. From the following description, it will be apparent that various changes may be made without departing from the spirit and scope of the disclosure as defined herein.

Accordingly, what is disclosed herein is a flexible fishing knot protector that may be readily adopted for use on any fishing hook and line. The fishing knot protector will act to protect the fishing knot that attaches a hook, a lure, a swivel, or any other fishing device that uses a knot to attach to the fishing line. This will reduce the likelihood of the knot becoming entangled in weeds or moss or other obstructions in the water when reeling the hook and line back in. The fishing knot protector can also protect the integrity of the knot from abrasions or other damage that may be caused through routine fishing practices.

In one embodiment of the invention, the fishing knot protector will have a body with a base and a tip. The tip of the body has an aperture. Preferably, the fishing knot protector will be of a conical shape with a circular base. The base will have a defined cavity for housing the knot and preferably the eye of a hook. Preferably, the fishing knot protector will be constructed of a durable, flexible material.

The fishing knot protector may be of variable sizes configured to secure a variety of hook sizes and fishing line. The size of the body of the fishing knot protector will correspond to the increase or decrease of the base. The tip, and corresponding aperture, may vary depending on the size of the fishing line the fishing knot protector is being used on.

The base of the body has a circular flexible flange that extends inward into the base and is configured to secure the eye of the hook in the fishing knot protector body. The body of the fishing knot protector has at least one cavity for housing the knot and, preferably, the eye of the hook. The flexible flange extends inward to the first cavity. The first cavity is configured to securely house the eye of a hook. The first cavity is preferably spherical. The first cavity is located in the body near the base of the body, with the circular flexible flange forming at the top of the cavity relative to the tip. The circular flange is configured to pass over the knot and eye of the hook and to retain the fishing knot protector by being positioned against the base of the eye of the hook.

The fishing knot protector also has a passageway. The passageway is configured to provide an opening for the fishing line to pass through the fishing knot protector body. The passageway frictionally secures the fishing knot protector in place along the fishing line. The passageway is a channel and extends from the aperture of the tip to the first cavity. The aperture of the tip is configured to allow the fishing line to pass through.

The fishing knot protector may have additional cavities. In a different embodiment, a second cavity is configured to securely house the knot attaching the hook to the fishing line. The second cavity is preferably spherical but being smaller in size when compared to the first cavity. The second cavity is adjacent to and positioned below the first cavity relative to the tip. The second cavity is connected to the first cavity. In this second embodiment, the passageway is configured to connect the aperture of the tip to the second cavity.

### BRIEF DESCRIPTION OF THE DRAWINGS

FIG. 1 illustrates a perspective view of an embodiment of a fishing knot protector.

FIG. 2 illustrates an isometric view of the embodiment of a fishing knot protector of FIG. 1.

FIG. 3 illustrates a perspective section view of the interior of a preferred embodiment of a fishing knot protector.

FIG. 4 illustrates an isometric section view of the interior of a preferred embodiment of a fishing knot protector including a fishing line attached to a fishing hook by a knot.

FIG. 5 illustrates a perspective view of an embodiment of a fishing knot protector with a wire guide positioned through the fishing knot protector for drawing fishing line through the fishing knot protector.

### DETAILED DESCRIPTION OF THE DRAWINGS

In the following description and in the figures, like elements are identified with like reference numerals. The use of “e.g.,” “etc,” and “or” indicates non-exclusive alternatives without limitation unless otherwise noted. The use of “including” means “including, but not limited to,” unless otherwise noted.

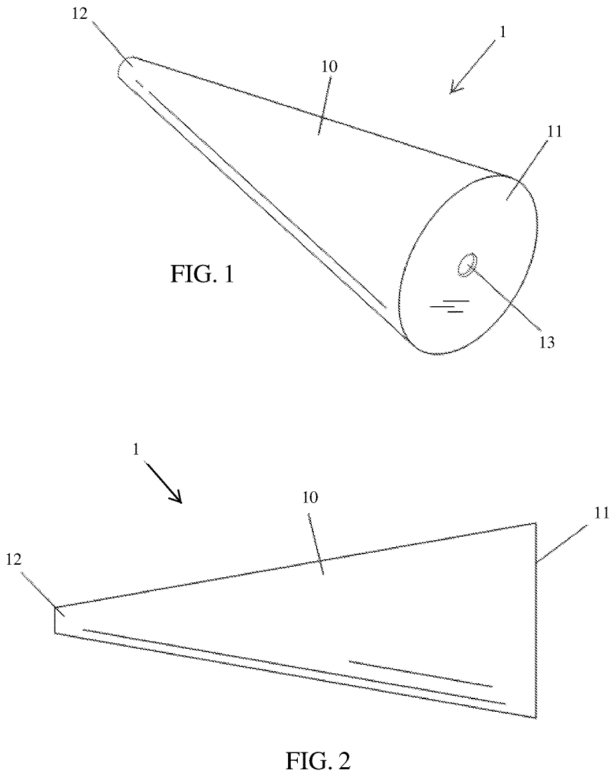

FIGS. 1 and 2 illustrate a perspective view of a first embodiment of the fishing knot protector. FIG. 1 illustrates the fishing knot protector 1 having a body 10. The fishing knot protector 1 is preferably conical in shape having a circular base 11. The fishing knot protector 1 is preferably constructed from a durable, flexible material.

The body 10 has a base 11 and a tip 12. The base 11 has a flange 13 that extends inward to an aperture narrower than the circumference of a first cavity 14. The flange 13 is flexible. The flange 13 is configured to secure a hook in the fishing knot protector 1 body 10.

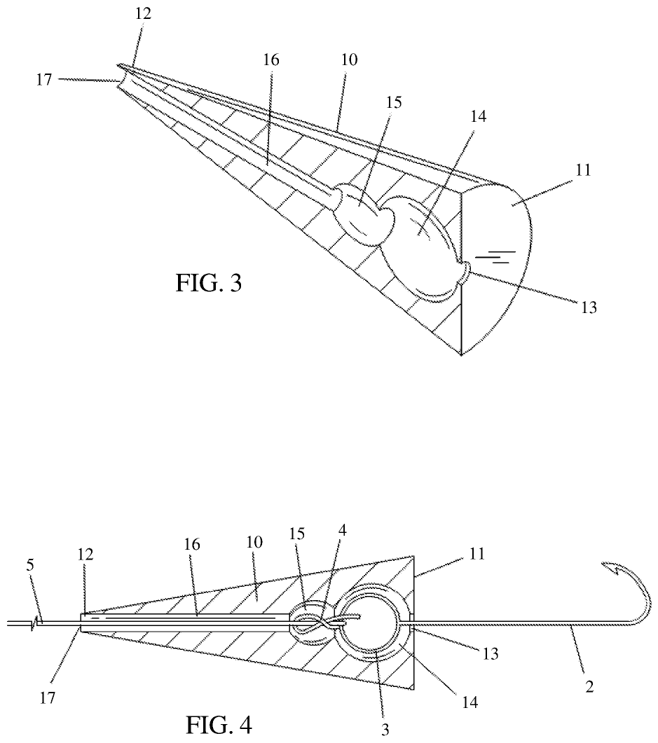

FIGS. 3 and 4 illustrate a cross-sectional view of a first embodiment of the fishing knot protector. FIG. 3 illustrates the body 10 having a base 11 and a tip 12. The base 11 has a flange 13 which extends inward. The flange 13 is configured to be flexible and secure the eye of the hook against it. The base 11 has a first cavity 14 internally. The first cavity 14 is configured to fit the eye of a hook. The first cavity 14 is preferably spherical in shape. Further illustrated in FIG. 3 is a second cavity 15. The second cavity 15 is configured to securely fit the knot that attaches the hook to the fishing line. The second cavity 15 is located internal to the body 10. The second cavity is adjacent to and positioned below the first cavity 14 relative to the tip 12.

There is a passageway 16 which extends from the bottom of the second cavity 15 to the tip 12. The passageway 16 is adjacent to and positioned below the second cavity 15 relative to the tip 12. The passageway 16 is configured as a channel that allows the fishing line to pass through the fishing knot protector 1 body 10. The passageway 16 is configured to be of a size that will be tight to the fishing line 5 so as to create friction between the line and the walls of the passageway to assist in maintaining the fishing knot protector in place. The tip 12 has an aperture 17 that connects to the passageway 16. The passageway 16 connected with the aperture 17 creates an axis line of the body 10 from the tip 12 to the base 11. The axis line runs through the middle of the flange 13 and through the middle of the aperture 17.

FIG. 4 illustrates a cross-sectional view of an embodiment of the invention with a fishing line with a knot connecting the fishing line to a hook. The hook 2 is secured by the flange 13 of the base 11. The hook 2 has an eye 3 that is securely located in the first cavity 14. The fishing line 5 passes through the aperture 17 of the tip 12. The fishing line 5 runs through the passageway 16. The fishing line 5 runs along the axis line created between the tip 12 and the base 11. The fishing line 5 ends in a knot 4 which attaches the fishing line to the eye 3 of the hook 2. The knot 4 is securely located in the second cavity 15.

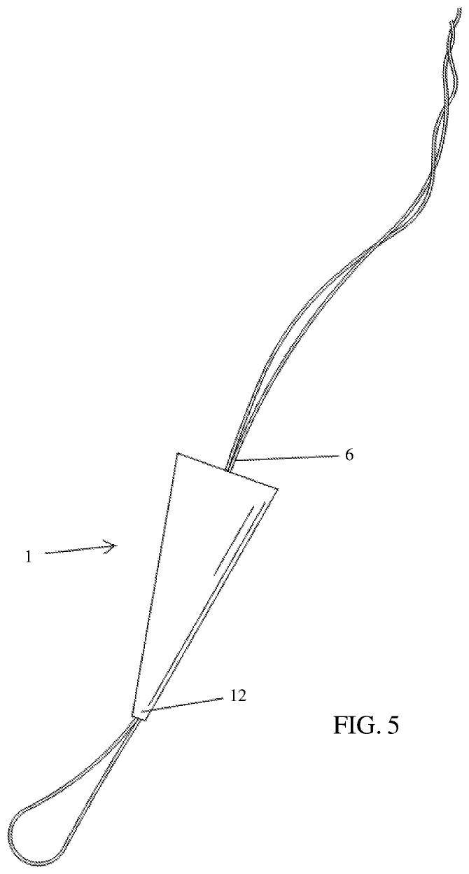

FIG. 5 illustrates the fishing knot protector 1 with a pre-fit wire leader, used to draw the fishing line through the fishing knot protector. The pre-fit wire leader 6 runs through the fishing knot protector 1. The pre-fit wire leader 6 passes completely through the base 11 and the tip 12. The pre-fit wire leader 6 passes through the fishing knot protector 1 along the axis line created between the tip 12 and the base 11.

Still other features and advantages of the presently disclosed and claimed inventive concept(s) will become readily apparent to those skilled in this art from the following detailed description describing preferred embodiments of the inventive concept(s), simply by way of illustration of the embodiments contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

I claim:

1. A fishing knot protector device comprising:
a body, said body having a base and a tip and at least one internal cavity;
wherein said cavity of said body being positioned at said base of said body;
wherein said base is circular in shape and having a flexible flange extending inward such that an aperture at the center of said flange has a narrower diameter than a diameter of said cavity to secure the eye of a fishing device, said flange being centrally positioned on said base; and
wherein said tip has an aperture configured to connect said tip to said cavity.

2. The fishing knot protector device of claim 1 wherein said body is conical in shape.

3. The fishing knot protector device of claim 1 wherein said cavity is spherical in shape.

4. The fishing knot protector device of claim 3 wherein said cavity is configured to house the eye of a hook, lure, swivel, or any other device used in fishing where a knot is used.

5. The fishing knot protector device of claim 1 wherein said body has a second cavity wherein said second cavity is adjacent to and positioned below said first cavity relative to said tip.

6. The fishing knot protector device of claim 5 wherein said second cavity is spherical in shape and smaller than said first cavity.

7. The fishing knot protector device of claim 5 wherein said second cavity is configured to securely house the knot connecting fishing line to the eye of a hook.

8. The fishing knot protector device of claim 5 wherein said second cavity is configured to connect said first cavity to said aperture of said tip.

9. The fishing knot protector device of claim 1 wherein said body has a passageway wherein said passageway is adjacent to and positioned below said cavity relative to said tip.

10. The fishing knot protector device of claim 9 wherein said passageway is in the shape of a channel and extends through said body to said aperture of said tip.

11. The fishing knot protector device of claim 9 wherein said passageway is configured to connect said aperture to said first cavity and said second cavity.

12. The fishing knot protector device of claim 1 wherein said body is constructed from a durable, flexible material.

13. The fishing knot protector device of claim 1, wherein said fishing device is selected from the group consisting of a hook, a lure, and a swivel.
